(19) United States
(12) Patent Application Publication
(10) Pub. No.: US 2017/0002775 A1
(43) Pub. Date: Jan. 5, 2017

(54) AIR INTAKE STRUCTURE FOR ENGINE

(71) Applicant: HONDA MOTOR CO., LTD., Tokyo (JP)

(72) Inventors: Hideaki Takada, Wako-shi (JP); Hibiki Koga, Wako-shi (JP); Toru Kawai, Wako-shi (JP)

(21) Appl. No.: 15/172,701

(22) Filed: Jun. 3, 2016

(30) Foreign Application Priority Data
Jun. 30, 2015 (JP) 2015-131381

(51) Int. Cl. F02M 35/10; F02M 35/02

(52) U.S. Cl. CPC F02M 35/10; F02M 35/02

(57) ABSTRACT

An air intake structure for an engine provided with an air cleaner near an exhaust muffler includes: a case defining an air intake chamber; an air cleaner element housed in the case to divide the air intake chamber into a dust chamber and a clean chamber; a first air inlet formed in a part of the case close to the exhaust muffler such that the first air inlet communicates the dust chamber with an exterior of the case; a second air inlet formed in a part of the case distant from the exhaust muffler such that the second air inlet communicates the dust chamber with an exterior of the case; a communication opening formed in the case so as to communicate the clean chamber with an air intake passage; and an opening and closing mechanism for selectively opening and closing at least one of the first and second air inlets.

### TECHNICAL FIELD

The present invention relates to an air intake structure for an engine, which is provided with an air cleaner disposed in a vicinity of an exhaust muffler.

### BACKGROUND OF THE INVENTION

When cold starting an internal combustion engine (hereinafter, simply referred to as an engine), if the temperature of the intake air supplied to the engine is low, the startability of the engine and the combustion stability of the same after start-up may be reduced. Therefore, at cold start, it is preferable to supply warm air to the engine to warm up the engine quickly. Particularly, in the case of an engine for a mechanical device used at a low temperature, such as a snowplow, for example, it is desirable to supply warm air to the engine at cold start. Then, after warm-up, it is preferable to supply cold air to the engine to improve the fuel efficiency.

An exhaust gas recirculation (EGR) mechanism, in which a part of the exhaust gas after combustion is suctioned back into the air intake passage, may be considered a technology that supplies warm air to the engine at cold start, though the primary purpose of the EGR mechanism is to improve the emission and fuel efficiency (see JP2008-163750A, for example). In the engine disclosed in JP2008-163750A, a wall disposed between the air intake port and the exhaust port of the cylinder head is provided with a communication hole serving as an EGR passage, such that a part of the exhaust gas discharged through the exhaust port is circulated back to the air intake port via the communication hole. Further, in this engine, an engine temperature detection mechanism (opening area varying member) constituted of a temperature-sensitive expandable member, etc. is disposed in the EGR passage to adjust the amount of recirculation of the exhaust gas depending on the engine temperature.

However, in the engines utilizing the EGR mechanism such as that shown in JP2008-163750A, it is necessary to form the EGR passage in the engine, and further, recirculation of the exhaust gas at cold start may lead to an ignition misfire. Moreover, because it is necessary to adjust the amount of recirculation of the exhaust gas depending on the temperature or the operation state of the engine, an additional structure such as a mechanism or a sensor to detect the temperature or the operation state of the engine is necessary. Thus, there are problems that the overall structure of the engine becomes complicated and the overall cost of the engine is increased.

### SUMMARY OF THE INVENTION

In view of the forgoing prior art problems, an object of the present invention is to provide an air intake structure for an engine such that the air intake structure can improve the startability and fuel efficiency of the engine with a simple structure and at low cost.

To achieve the above object, according to an aspect of the present invention, there is provided an air intake structure for an engine provided with an air cleaner disposed in a vicinity of an exhaust muffler, the air cleaner including: a case defining an air intake chamber; an air cleaner element housed in the case to divide the air intake chamber into a dust chamber and a clean chamber; a first air inlet formed in a part of the case at a position close to the exhaust muffler such that the first air inlet communicates the dust chamber with an exterior of the case; a second air inlet formed in a part of the case at a position distant from the exhaust muffler such that the second air inlet communicates the dust chamber with an exterior of the case; a communication opening formed in the case so as to communicate the clean chamber with an air intake passage for supplying air to a combustion chamber; and an opening and closing mechanism capable of selectively opening and closing at least one of the first and second air inlets.

According to this arrangement, because at least one of the first air inlet and the second air inlet can be selectively opened and closed, it is possible to easily adjust the temperature of the air supplied to the engine in dependence on an operational condition of the engine, to thereby improve the startability and fuel efficiency of the engine with a simple structure and at low cost. Preferably, at start-up, particularly at cold start, relatively warm air is introduced into the engine through the first air inlet, which is formed at a position close to the exhaust muffler, while during normal operation such as during rated load operation after warm-up of the engine, relatively cold air is introduced into the engine through the second air inlet, which is formed at a position distant from the exhaust muffler.

In the above air intake structure, the opening and closing mechanism may include a member configured to be movable to a first position and a second position, wherein at the first position, the member closes the first air inlet and opens the second air inlet, and at the second position, the member opens the first air inlet and closes the second air inlet.

According to this arrangement, by moving the movable member to the first position or the second position, it is possible to easily achieve selective opening and closing of the first and second air inlets.

Further, in the above air intake structure, the member may be configured to be movable to a third position where the member closes both the first and second air inlets.

According to this arrangement, by moving the movable member to the third position, it is possible to close both the first and second air inlets, whereby, when the engine is stopped, intrusion of dust into the air intake chamber of the air cleaner can be prevented.

Further, in the above air intake structure, preferably, the first and second air inlets are formed in a part of a wall of the case and the member includes a shutter plate rotatably movable along a surface of the wall so as to open and close the first and second air inlets.

According to this arrangement, the opening and closing mechanism is realized by use of a shutter plate which is simple in structure, and therefore, the air intake structure for an engine of the present invention can be achieved with a simple structure and at low cost.

Further, in the above air intake structure, the opening and closing mechanism may include a first valve installed at the first air inlet and a second valve installed at the second air inlet.

According to this arrangement, the opening and closing mechanism is realized by use of the first valve and the second valve, and therefore, by individually adjusting the opening of the first valve and the second valve, it is possible to control the temperature and amount of air introduced into the engine easily and precisely.

Further, in the above air intake structure, the opening and closing mechanism may be connected to a choke mechanism of the engine via an interlocking mechanism which causes the opening and closing mechanism to open the first air inlet and close the second air inlet when an opening degree of a choke valve is smaller than a first predetermined choke valve opening degree, and to cause the opening and closing mechanism to close the first air inlet and open the second air inlet when the opening degree of the choke valve is larger than a second predetermined choke valve opening degree that is larger than or equal to the first predetermined choke valve opening degree.

According to this arrangement, it is possible to selectively open and close the first and second air inlets depending on the opening degree of the choke valve. Consequently, at start-up (particularly at cold start), namely, when the opening degree of the choke valve is smaller than the first predetermined choke valve opening degree, warm air introduced through the first air inlet can be supplied to the engine, while during normal operation, namely, when the opening degree of the choke valve is larger than the second predetermined choke valve opening degree, cold air introduced through the second air inlet can be supplied to the engine. Thereby, it is possible to easily adjust the temperature of the air supplied to the engine and to improve the startability and fuel efficiency of the engine.

Further, in the above air intake structure, the opening and closing mechanism may be connected to a throttle mechanism of the engine via an interlocking mechanism which causes the opening and closing mechanism to open the first air inlet and close the second air inlet when an opening degree of a throttle valve is smaller than a first predetermined throttle valve opening degree, and to cause the opening and closing mechanism to close the first air inlet and open the second air inlet when the opening degree of the throttle valve is larger than a second predetermined throttle valve opening degree that is larger than or equal to the first predetermined throttle valve opening degree.

According to this arrangement, it is possible to selectively open and close the first and second air inlets depending on the opening degree of the throttle valve. Consequently, at start-up (particularly at cold start), namely, when the opening degree of the throttle valve is smaller than the first predetermined throttle valve opening degree, warm air introduced through the first air inlet can be supplied to the engine, while during normal operation, namely, when the opening degree of the throttle valve is larger than the second predetermined throttle valve opening degree, cold air introduced through the second air inlet can be supplied to the engine. Thereby, it is possible to easily adjust the temperature of the air supplied to the engine and to improve the startability and fuel efficiency of the engine.

Further, the above air intake structure may further include: a drive unit that drives the opening and closing mechanism; a controller that controls the drive unit; and at least one sensor selected from the group consisting of a choke valve opening degree sensor, a throttle valve opening degree sensor, an intake air temperature sensor, an engine temperature sensor, an oil temperature sensor and a water temperature sensor, wherein the controller controls the drive unit based on a result of detection by the at least one sensor to drive the opening and closing mechanism.

According to this arrangement, it is possible to drive the opening and closing mechanism based on at least one of the opening degree of the choke valve, the opening degree of the throttle valve, the temperature of the intake air, the temperature of the engine, the temperature of the engine oil and the temperature of the cooling water. Thereby, it becomes possible to easily adjust the temperature of the air supplied to the engine, and to improve the startability and fuel efficiency of the engine.

As described above, according to an aspect of the present invention, it is possible to provide an air intake structure for an engine such that the air intake structure can improve the startability and fuel efficiency of the engine with a simple structure and at low cost.

### BRIEF DESCRIPTION OF THE DRAWINGS

Now the present invention is described in the following with reference to the appended drawings, in which:

FIG. 1 is a schematic configuration diagram of an engine according to the first embodiment of the present invention, in which an air cleaner is shown in a side cross-sectional view;

FIG. 2 is an enlarged view of the air cleaner shown in FIG. 1;

FIG. 3 is a top view of a lower case of the air cleaner shown in FIG. 1;

FIGS. 4A and 4B are diagrams showing positions of a shutter plate, in which FIG. 4A shows a first position and FIG. 4B shows a second position;

FIGS. 5A and 5B are diagrams showing positions of the shutter plate, in which FIG. 5A shows a third position and FIG. 5B shows a fourth position;

FIG. 6 is a side cross-sectional view of an air cleaner according to the second embodiment of the present invention;

FIG. 7 is a top view of a lower case of the air cleaner according to the second embodiment of the present invention;

FIG. 8 is a schematic configuration diagram of an engine according to the third embodiment of the present invention; and

FIG. 9 is a schematic configuration diagram of an engine according to the fourth embodiment of the present invention.

### DETAILED DESCRIPTION OF THE PREFERRED EMBODIMENTS

In the following, embodiments of the present invention will be described in detail with reference to the drawings.

### First Embodiment

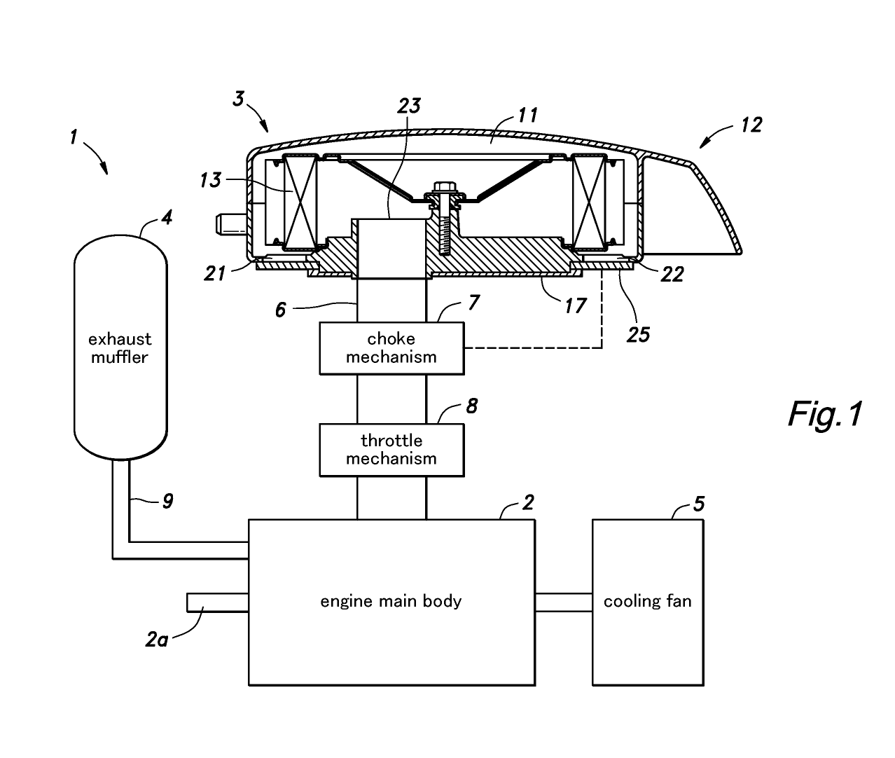

FIG. 1 is a schematic configuration diagram of an engine according to the first embodiment of the present invention. The engine relating to the present invention is a general gasoline engine, and may be used as an engine for a snowplow, for example.

As shown in FIG. 1, the engine 1 includes an engine main body 2, an air cleaner 3, an exhaust muffler 4 and a cooling fan 5. The engine main body 2 includes a cylinder, a crankcase, a cylinder head, a piston, a con rod, a crankshaft 2a, etc., and the crankshaft 2a protrudes from the engine main body 2 in left and right horizontal directions. The air cleaner 3, which is shown in a cross-sectional view in FIG. 1, is disposed above the engine main body 2, and the exhaust muffler 4 is disposed near the air cleaner 3. Further, the exhaust muffler 4 is disposed on one end side of the crankshaft 2a of the engine main body 2 (on the left side in the drawing). The cooling fan 5 is joined to the other end of the crankshaft 2a of the engine main body 2 (the right end in the drawing). Namely, the exhaust muffler 4 and the cooling fan 5 are located on opposite sides of the engine main body 2 to interpose the engine main body 2 therebetween.

The engine main body 2 and the air cleaner 3 are connected to each other by an air intake passage 6, so that the air purified at the air cleaner 3 flows through the air intake passage 6 and is supplied to the combustion chamber of the engine main body 2. Provided on the air intake passage 6 are a choke mechanism 7 and a throttle mechanism 8. The choke mechanism 7 may be an automatic choke, for example. The engine main body 2 and the exhaust muffler 4 are connected to each other by an exhaust passage 9, so that the burned gas generated in the combustion chamber of the engine main body 2 is sent to the exhaust muffler 4 through the exhaust passage 9, and then is discharged to the outside.

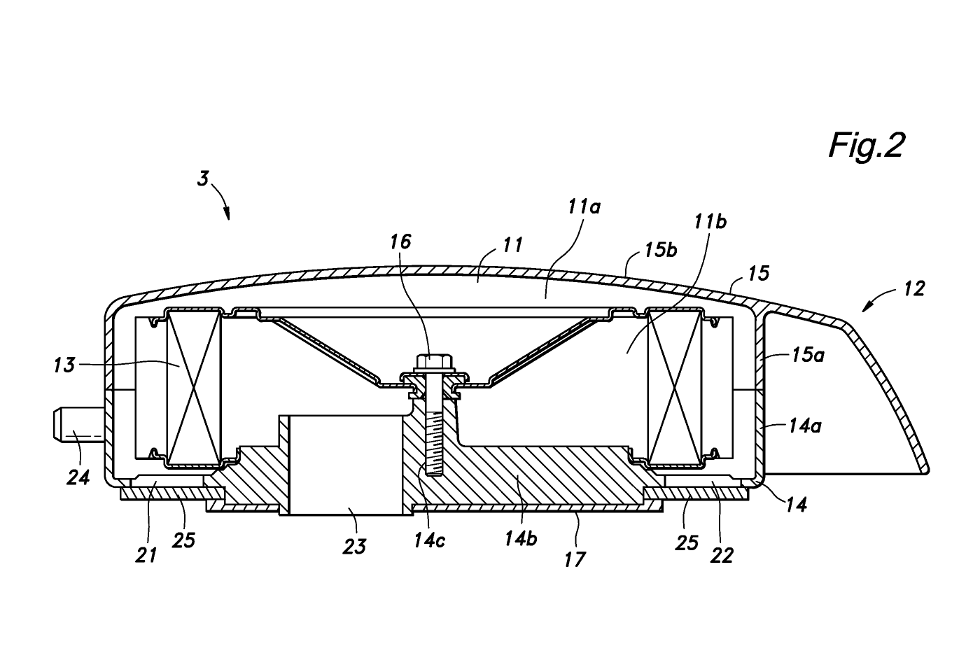

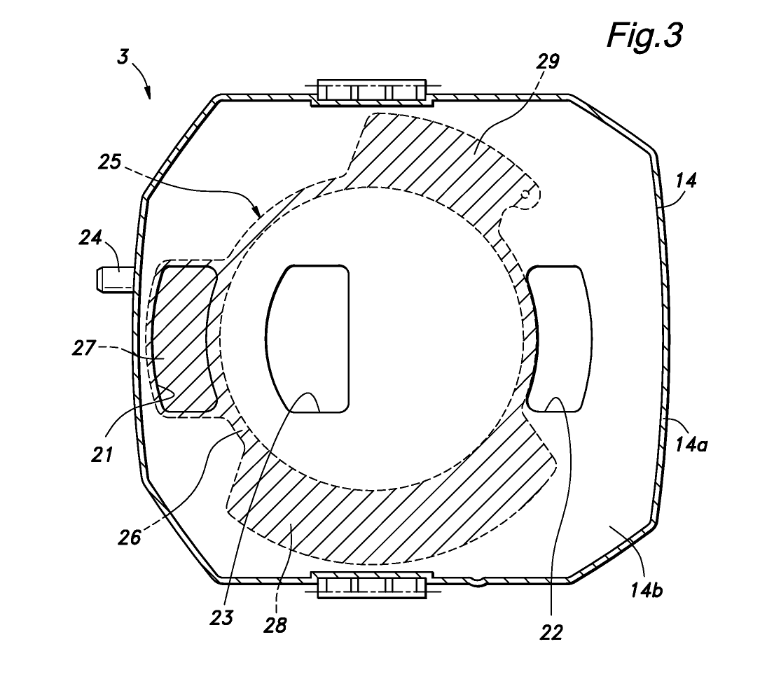

FIG. 2 is an enlarged view of the air cleaner 3 shown in FIG. 1, and FIG. 3 is a top view of a lower case 14 of the air cleaner 3. It is to be noted that in FIG. 3, an air cleaner element 13 and an upper case 15 are omitted, and some features of the lower case 14 such as a mounting hole 14c are omitted for clarity purposes. As shown in FIG. 2, the air cleaner 3 includes a substantially rectangular box-shaped case 12 that defines an air intake chamber 11, and an air cleaner element 13 housed in the case 12. The air intake chamber 11 is divided by the air cleaner element 13 into a dust chamber 11a and a clean chamber 11b.

The case 12 is constituted of a lower case 14 and an upper case 15. The lower case 14 includes a circumferential wall 14a having a substantially rectangular tube-like shape and a bottom wall 14b closing a lower opening of the circumferential wall 14a. The upper case 15 includes a circumferential wall 15a having a substantially rectangular tube-like shape and an upper wall 15b closing an upper opening of the circumferential wall 15a. The upper case 15 is configured to be detachable from the lower case 14 to enable maintenance of the air cleaner element 13. The air cleaner element 13 is secured to the bottom wall 14b of the lower case 14 by a bolt 16 screwed into a mounting hole 14c formed in the bottom wall 14b.

As shown in FIGS. 2 and 3, the bottom wall 14b of the lower case 14 of the air cleaner 3 is provided with a first air inlet 21 communicating the dust chamber 11a with an exterior of the case 12, a second air inlet 22 communicating the dust chamber 11a with an exterior of the case 12, and a communication opening 23 communicating the clean chamber 11b with the air intake passage 6, such that the air inlets 21 and 22 and the communication opening 23 extend through the bottom wall 14b. The first air inlet 21 and the second air inlet 22 are formed to have a substantially same size. The communication opening 23 is formed to be slightly larger than the first air inlet 21 and the second air inlet 22.

The first air inlet 21 is formed in a part of the bottom wall 14b of the lower case 14 close to the exhaust muffler 4, while the second air inlet 22 is formed in a part of the bottom wall 14b of the lower case 14 distant from the exhaust muffler 4, whereby the distance between the first air inlet 21 and the exhaust muffler 4 is smaller than the distance between the second air inlet 22 and the exhaust muffler 4. Specifically, the first air inlet 21 and the second air inlet 22 are provided on opposite sides of a laterally central part of the bottom wall 14b of the lower case 14 such that the first air inlet 21 and the second air inlet 22 interposes the central part of the bottom wall 14b therebetween. Each of the first air inlet 21 and the second air inlet 22 has one end opened to the atmosphere and the other end opened to the dust chamber 11a of the air intake chamber 11. It is to be noted that the end of each of the first air inlet 21 and the second air inlet 22 opened to the atmosphere faces downward so that dust, water, snow, etc. will not enter the air intake chamber 11.

The communication opening 23 is formed in a region between the first air inlet 21 and the second air inlet 22 at a position adjacent to the first air inlet 21. The communication opening 23 has one open end connected to the air intake passage 6 and the other end opened in the clean chamber 11b of the air intake chamber 11. It is to be noted that the position of the communication opening 23 is not limited to the above position, and may be any other position. Further, a part of the circumferential wall 14a of the lower case 14 near the first air inlet 21 is provided with hole (not shown in the drawing) into which a blow-by gas return pipe 24 which communicates with a breather chamber is fitted.

Further, the air cleaner 3 includes a shutter plate 25 which is disposed under the first air inlet 21 and the second air inlet 22. The shutter plate 25 is configured to be rotatably movable along the outer surface (under surface in the illustrated embodiment) of the bottom wall 14b of the lower case 14 to open and close the first air inlet 21 and the second air inlet 22. The shutter plate 25 corresponds to an opening and closing mechanism in the claims. The shutter plate 25 is rotatably supported by a support mechanism including a shutter support 17 attached to the underside of the bottom wall 14b of the lower case 14. The support mechanism is not particularly limited, and may include a structure in which the shutter plate 25 is simply disposed on the shutter support 17 as shown in FIG. 2, for example.

As shown in FIG. 3, the shutter plate 25 includes a substantially ring-shaped main body 26 and a first extension portion 27, a second extension portion 28 and a third extension portion 29 which are formed to protrude a predetermined length from the main body 26 outward in the radial direction. The first, second and third extension portions 27, 28 and 29 are arranged counterclockwise in this order such that a predetermined space is defined between adjacent ones of these extension portions 27, 28 and 29. The first extension portion 27 and the third extension portion 29 are formed to have a substantially same size, which is determined to be slightly larger than the size of each of the first air inlet 21 and the second air inlet 22 so that, when aligned with the air inlet 21 or 22, each of the first extension portion 27 and the third extension portion 29 can close the air inlet 21 or 22. The second extension portion 28 is provided with a circumferential dimension approximately twice as large as that of each of the first extension portion 27 and the third extension portion 29. Thereby, a circumferential half section of the second extension portion 28 can close the first air inlet 21 or the second air inlet 22 when aligned with the air inlet 21 or 22.

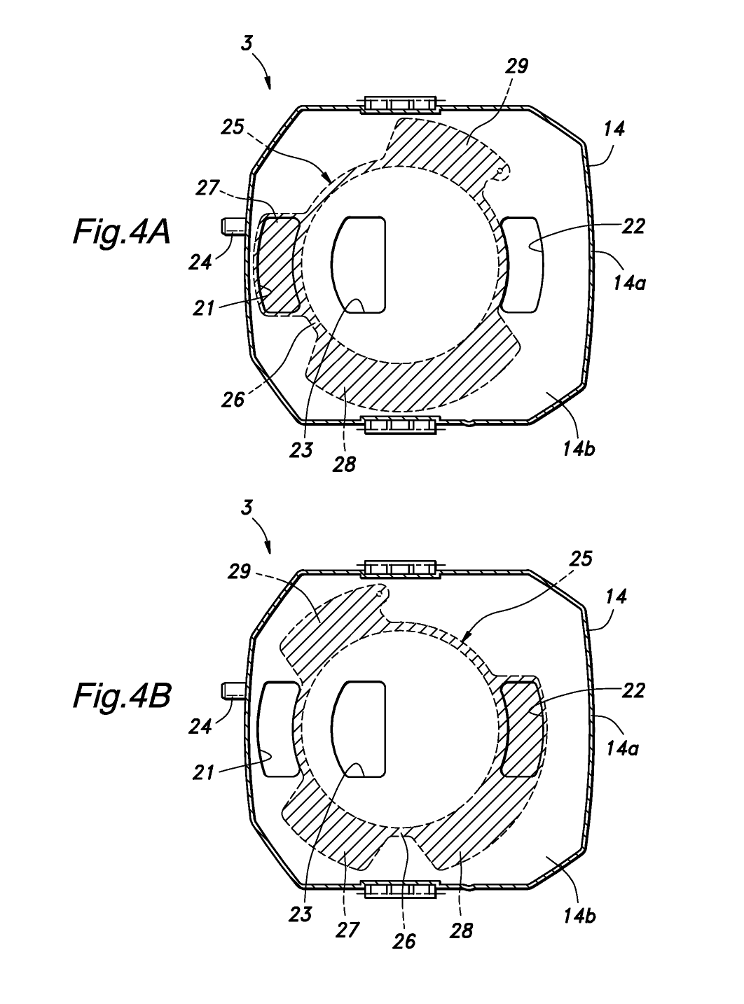

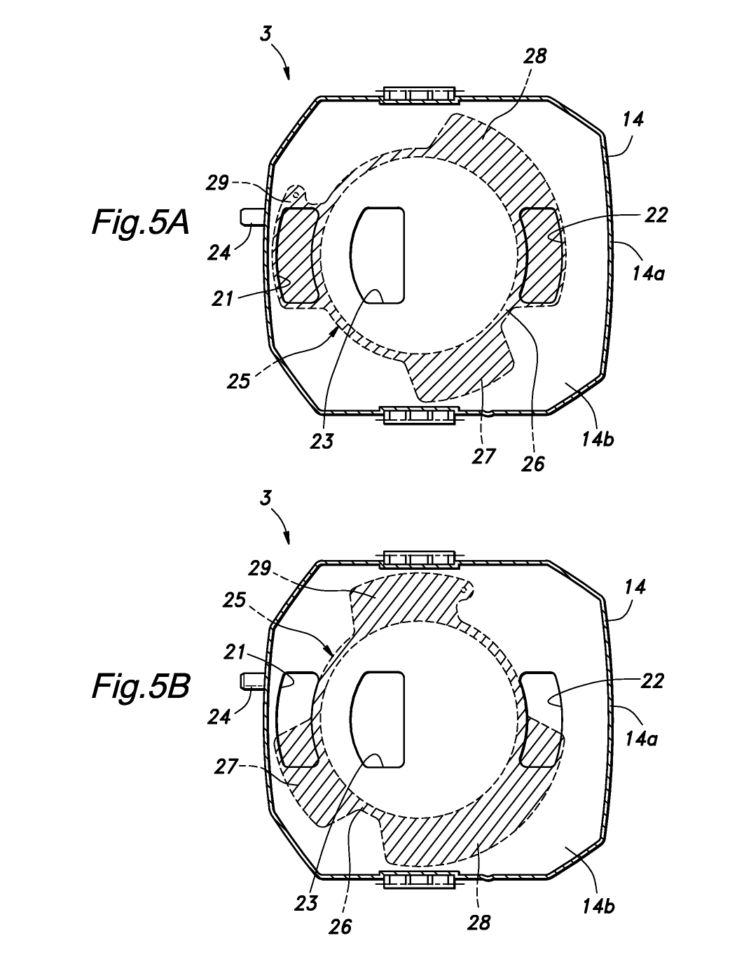

Depending on the position, the shutter plate 25 can selectively open and close the first air inlet 21 and the second air inlet 22 with the extension portions 27-29. FIGS. 4A, 4B, 5A and 5B are drawings showing exemplary positions of the shutter plate 25, in which FIG. 4A shows a first position, FIG. 4B shows a second position, FIG. 5A shows a third position, and FIG. 5B shows a fourth position. The second position shown in FIG. 4B is a position that the shutter plate 25 takes when the shutter plate 25 is rotated about 60 degrees counterclockwise from the first position shown in FIG. 4A, the third position shown in FIG. 5A is a position that the shutter plate 25 takes when the shutter plate 25 is rotated about 60 degrees counterclockwise from the second position shown in FIG. 4B, and the fourth position shown in FIG. 5B is a position that the shutter plate 25 takes when the shutter plate 25 is rotated about 30 degrees counterclockwise from the first position shown in FIG. 4A.

At the first position shown in FIG. 4A, the first extension portion 27 of the shutter plate 25 fully overlaps the first air inlet 21. Thereby, the first air inlet 21 is closed by the first extension portion 27 of the shutter plate 25. At this time, the second extension portion 28 and the third extension portion 29 are each positioned between the first air inlet 21 and the second air inlet 22. Therefore, the second air inlet 22 is in an open state. Thus, the shutter plate 25 can take the first position where the first air inlet 21 is closed and the second air inlet 22 is opened.

At the second position shown in FIG. 4B, the counterclockwise-side half (the half part on the side of the third extension portion 29) of the second extension portion 28 of the shutter plate 25 fully overlaps the second air inlet 22. Thereby, the second air inlet 22 is closed by the second extension portion 28 of the shutter plate 25. At this time, the first extension portion 27 and the third extension portion 29 are each positioned between the first air inlet 21 and the second air inlet 22. Therefore, the first air inlet 21 is in an open state. Thus, the shutter plate 25 can take the second position where the first air inlet 21 is opened and the second air inlet 22 is closed.

At the third position shown in FIG. 5A, the third extension portion 29 fully overlaps the first air inlet 21, and the clockwise-side half (the half part on the side of the first extension portion 27) of the second extension portion 28 overlaps the second air inlet 22. Thereby, both the first air inlet 21 and the second air inlet 22 are closed by the third extension portion 29 and the second extension portion 28, respectively. At this time, the first extension portion 27 is positioned between the first air inlet 21 and the second air inlet 22. Thus, the shutter plate 25 can take the third position where the first air inlet 21 and the second air inlet 22 are both closed.

The shutter plate 25 is coupled to the choke mechanism 7 via an interlocking mechanism schematically shown by a broken line in FIG. 1 such that the shutter plate 25 is rotated in accordance with the opening degree of the choke valve. Specifically, a configuration is made such that when the choke valve is fully closed, the shutter plate 25 is rotated to the second position (namely, opens the first air inlet 21 and closes the second air inlet 22), and when the choke valve is fully opened, the shutter plate 25 is rotated to the first position (namely, closes the first air inlet 21 and opens the second air inlet 22). The interlocking mechanism mentioned above is not particularly limited, and any known interlocking mechanism, such as a mechanical interlocking mechanism using gears, wires, links, etc., may be used.

The air cleaner 3 configured as described above operates as follows. First, at start-up of the engine 1, particularly at cold start, the choke valve is fully closed (an example of a state where the opening degree of the choke valve is smaller than a first predetermined choke valve opening degree) to make a fuel-rich mixture. At this time, the shutter plate 25 is rotated to the second position (see FIG. 4B), whereby the first air inlet 21 is opened and the second air inlet 22 is closed. Consequently, warm air around the exhaust muffler 4 is introduced into the air intake chamber 11 of the air cleaner 3 through the first air inlet 21. Then, after being purified by the air cleaner element 13, the warm air is supplied to the engine main body 2 via the air intake passage 6. Thus, because the engine 1 is supplied with warm air, the startability of the engine 1 is improved.

On the other hand, during normal operation such as during rated load operation after warm-up of the engine 1, the choke valve is fully opened (an example of a state where the opening degree of the choke valve is larger than a second predetermined choke valve opening degree that is larger than or equal to the first predetermined choke valve opening degree) to make a fuel-lean mixture. At this time, the shutter plate 25 is rotated to the first position (see FIG. 4A), whereby the first air inlet 21 is closed and the second air inlet 22 is opened. Consequently, air at a position distant from the exhaust muffler 4 is introduced into the air intake chamber 11 of the air cleaner 3 through the second air inlet 22. Thus, during normal operation, outside cold air is introduced into the air intake chamber 11 through the second air inlet 22. Then, after being purified by the air cleaner element 13, the cold air is supplied to the engine main body 2 via the air intake passage 6. Thus, because the engine 1 is supplied with cold air, the fuel combustion efficiency of the engine 1 is improved. Namely, the fuel efficiency of the engine 1 is improved.

When the engine 1 is stopped, the shutter plate 25 is rotated to the third position (see FIG. 5A), whereby the first air inlet 21 and the second air inlet 22 are both closed. Thereby, intrusion of dust or the like into the air intake chamber 11 of the air cleaner 3 can be prevented.

It is to be noted that the opening degrees of the first air inlet 21 and the second air inlet 22 may be adjusted in accordance with the opening degree of the choke valve. For instance, in an operational range between the cold start and the normal operation, both the first air inlet 21 and the second air inlet 22 may be partially opened, as shown in FIG. 5B in which the shutter plate 25 is at the fourth position. By thus adjusting the opening degrees of the first air inlet 21 and the second air inlet 22, it is possible to freely control the temperature of the air supplied to the engine main body 2.

### Second Embodiment

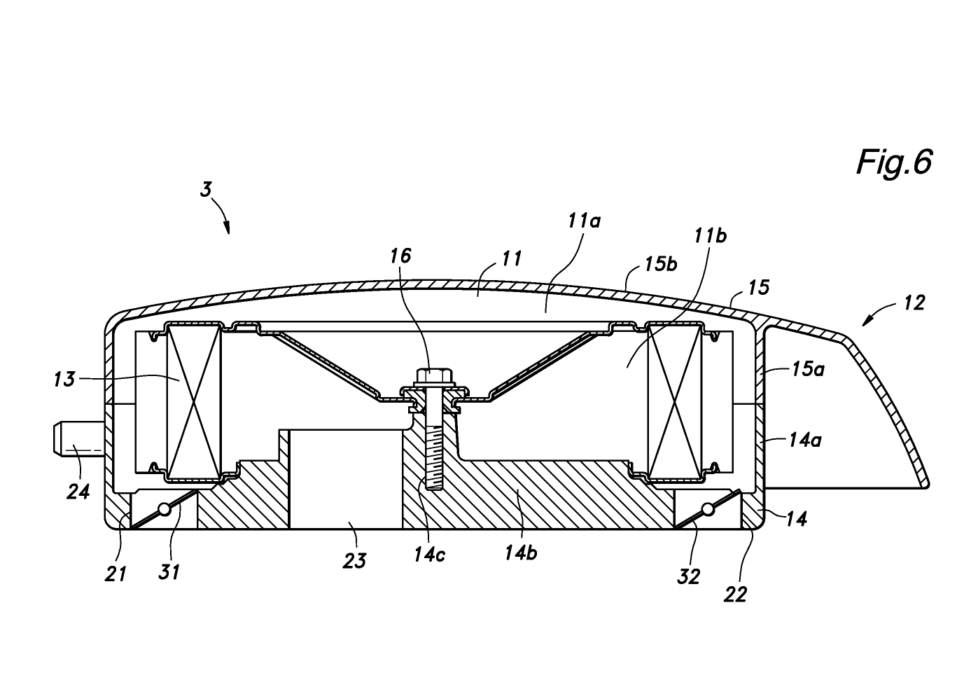

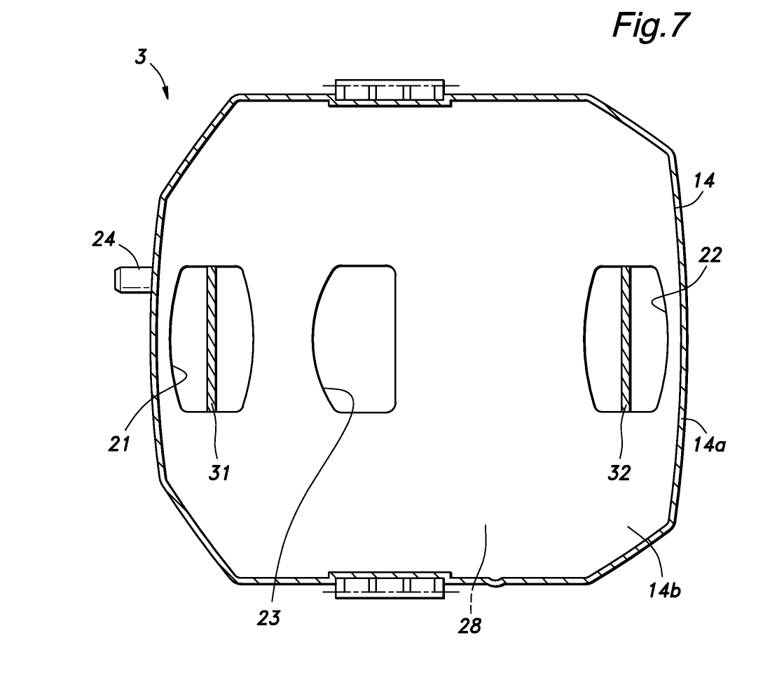

Next, the second embodiment of the engine according to the present invention will be described with reference to FIG. 6 and FIG. 7. The second embodiment is different from the above-described first embodiment in that a first valve 31 and a second valve 32 are used instead of the shutter plate 25 as the opening and closing mechanism. The parts same as or similar to those of the first embodiment are denoted by the same reference signs and the description thereof is omitted.

As shown in FIGS. 6 and 7, the first valve 31 is installed at the first air inlet 21, and the second valve 32 is installed at the second air inlet 22. The first valve 31 and the second valve 32 each may be a butterfly valve, for example, though the type of the first valve 31 and the second valve 32 is not limited thereto and various other types of valves such as a gate valve may be used.

The first valve 31 and the second valve 32 is coupled to the choke mechanism 7 via the interlocking mechanism (not shown in FIGS. 6 and 7), such that the first valve 31 and the second valve 32 are driven to open and close in accordance with the opening degree of the choke valve. Specifically, when the choke valve is fully opened, the first valve 31 opens the first air inlet 21 and the second valve 32 closes the second air inlet 22. On the other hand, when the choke valve is fully closed, the first valve 31 closes the first air inlet 21 and the second valve 32 opens the second air inlet 22. When the engine 1 is stopped, the first valve 31 closes the first air inlet 21 and the second valve 32 closes the second air inlet 22. The interlocking mechanism mentioned above is not particularly limited, and any known interlocking mechanism, such as a mechanical interlocking mechanism using gears, wires, links, etc., may be used.

The air cleaner 3 configured as described above operates as follows. First, at start-up of the engine 1, particularly at cold start, the choke valve is fully closed to make a fuel-rich mixture. At this time, the first valve 31 opens the first air inlet 21 and the second valve 32 closes the second air inlet 22. Consequently, warm air around the exhaust muffler 4 is introduced into the air intake chamber 11 of the air cleaner 3 through the first air inlet 21. Then, after being purified by the air cleaner element 13, the warm air is supplied to the engine main body 2 via the air intake passage 6. Thus, because the engine 1 is supplied with warm air, the startability of the engine 1 is improved.

On the other hand, during normal operation such as during rated load operation after warm-up the engine 1, the choke valve is fully opened to make a fuel-lean mixture. At this time, the first valve 31 closes the first air inlet 21 and the second valve 32 opens the second air inlet 22. Consequently, air at a position distant from the exhaust muffler 4 is introduced into the air intake chamber 11 of the air cleaner 3 through the second air inlet 22. Thus, during normal operation, outside cold air is introduced into the air intake chamber 11 through the second air inlet 22. Then, after being purified by the air cleaner element 13, the cold air is supplied to the engine main body 2 via the air intake passage 6. Thus, because the engine 1 is supplied with cold air, the fuel combustion efficiency of the engine 1 is improved. In other words, the fuel efficiency of the engine 1 is improved.

When the engine 1 is stopped, the first valve 31 closes the first air inlet 21 and the second valve 32 closes the second air inlet 22. Thereby, intrusion of dust or the like into the air intake chamber 11 of the air cleaner 3 can be prevented. It is to be noted that the first valve 31 and the second valve 32 may be driven such that the opening degrees of the first air inlet 21 and the second air inlet 22 are adjusted in accordance with the opening degree of the choke valve as in the first embodiment described above.

### Third Embodiment

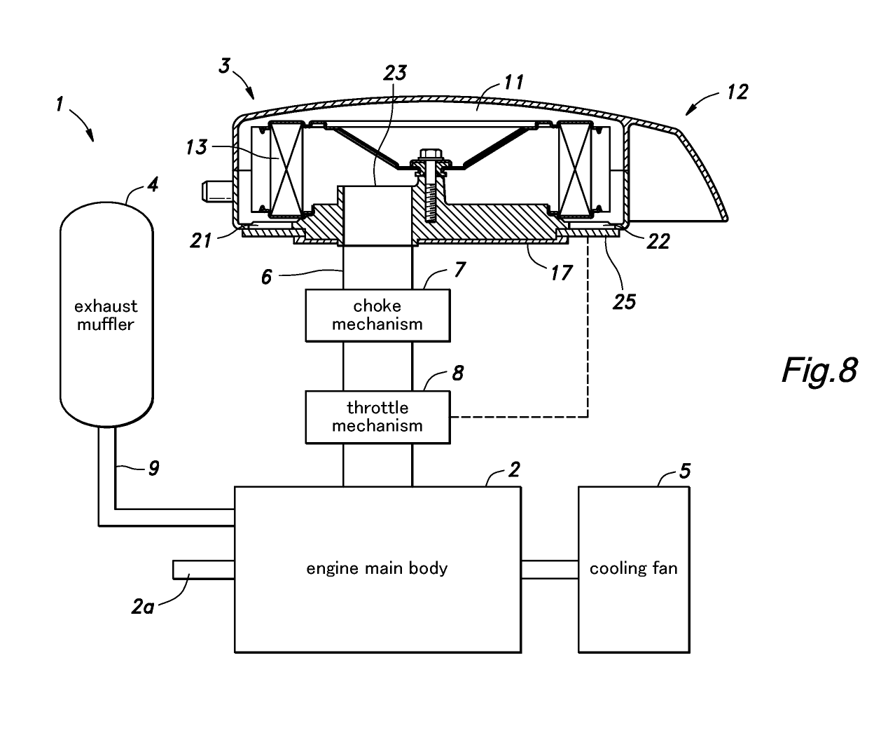

Next, the third embodiment of the engine according to the present invention will be described with reference to FIG. 8. The parts same as or similar to those of the first embodiment are denoted by the same reference signs and the description thereof is omitted.

In the first and second embodiments described above, a configuration was made such that the opening and closing mechanism (the shutter plate 25 or the first and second valves 31, 32) is driven in accordance with the opening degree of the choke valve. However, a configuration may be made such that the opening and closing mechanism is driven in accordance with the opening degree of the throttle valve, instead of the opening degree of the choke valve. In this case, as shown in FIG. 8, the opening and closing mechanism (the shutter plate 25 in this drawing) is coupled to the throttle mechanism 8 via an interlocking mechanism schematically shown by a broken line, such that the opening and closing mechanism is driven to open and close in accordance with the opening degree of the throttle valve. Specifically, the opening and closing mechanism 25 is coupled to the throttle mechanism 8 so as to open the first air inlet 21 and close the second air inlet 22 when the opening degree of the throttle valve is small (namely, smaller than a first predetermined threshold opening degree), and to close the first air inlet 21 and open the second air inlet 22 when the opening degree of the throttle valve is large (namely, larger than a second predetermined threshold opening degree that is larger than or equal to the first predetermined threshold opening degree). In this way it is possible to supply warm air to the engine main body 2 when the opening degree of the throttle valve is small at cold start, and to supply cold air to the engine main body 2 when the opening degree of the throttle valve is large during normal operation such as during rated load operation after warm-up, and therefore, the startability and fuel efficiency of the engine 1 are improved.

### Fourth Embodiment

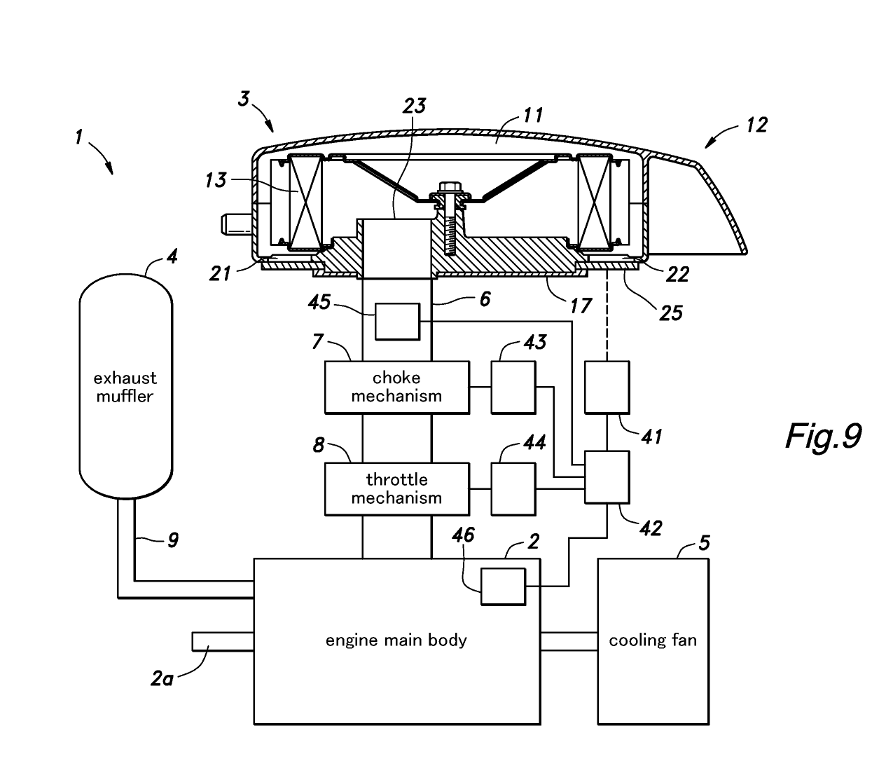

Next, the fourth embodiment of the engine according to the present invention will be described with reference to FIG. 9. The parts same as or similar to those of the first embodiment are denoted by the same reference signs and the description thereof is omitted.

In the first to third embodiments described above, a configuration was made such that the opening and closing mechanism (the shutter plate 25 or the first and second valves 31, 32) was driven by the interlocking mechanism coupled to the choke valve or the throttle valve, where the interlocking mechanism could be a mechanical interlocking mechanism. However, instead of the mechanical interlocking mechanism, a drive unit and a controller for controlling the drive unit may be used. For instance, as shown in FIG. 9, a configuration may be made to include a drive unit 41 for driving the opening and closing mechanism (the shutter plate 25 in this drawing), a controller 42 for controlling the drive unit 41 and a various sensors, such that the controller 42 controls the drive unit 41 to drive the opening and closing mechanism 25 on the basis of the detection results of the sensors.

The sensors may include a choke valve opening degree sensor 43, a throttle valve opening degree sensor 44, an intake air temperature sensor 45 provided to the air intake passage 6, an engine temperature sensor 46 provided to the engine main body 2, an oil temperature sensor (not shown in the drawing), and a water temperature sensor (not shown in the drawing). The drive unit 41 may include an actuator of any known type but preferably includes an electric actuator that uses an electric motor as a power source. The controller 42 controls the drive unit 41 to drive the opening and closing mechanism 25 on the basis of the information input from at least one of the choke valve opening degree sensor 43, the throttle valve opening degree sensor 44, the intake air temperature sensor 45, the engine temperature sensor 46, the oil temperature sensor (not shown in the drawing) and the water temperature sensor (not shown in the drawing).

For instance, the controller 42 controls the drive unit 41 to drive the opening and closing mechanism 25 on the basis of the temperature of the intake air detected by the intake air temperature sensor 45. Specifically, the controller 42 controls the drive unit 41 such that when the temperature of the intake air is low (namely, lower than a first predetermined intake air temperature), the opening and closing mechanism 25 opens the first air inlet 21 and closes the second air inlet 22, and when the temperature of the intake air is high (namely, higher than a second predetermined intake air temperature that is higher than or equal to the first predetermined intake air temperature), the opening and closing mechanism 25 closes the first air inlet 21 and opens the second air inlet 22.

Alternatively, for instance, the controller 42 controls the drive unit 41 to drive the opening and closing mechanism 25 on the basis of the temperature of the engine 1 detected by the engine temperature sensor 46. Specifically, the controller 42 controls the drive unit 41 such that when the temperature of the engine 1 is low (namely, lower than a first predetermined engine temperature), the opening and closing mechanism 25 opens the first air inlet 21 and closes the second air inlet 22, and when the temperature of the engine 1 is high (namely, higher than a second predetermined engine temperature that is higher than or equal to the first predetermined engine temperature), the opening and closing mechanism 25 closes the first air inlet 21 and opens the second air inlet 22.

Thus, by the controller 42 controlling the drive unit 41 to drive the opening and closing mechanism 25 on the basis of detection result of the one or more sensors, it is possible to adjust the temperature of the air supplied to the engine 1. Thereby, the startability and fuel efficiency of the engine 1 are improved.

In the foregoing, the present invention has been described in terms of the concrete embodiments thereof, but the present invention is not limited to the foregoing embodiments and various alterations and modifications may be made. The concrete structure, arrangement, number, angle, material, etc. of the component parts of the embodiments may be appropriately changed within the scope of the sprit of the present invention. Also, not all of the structural elements shown in the above embodiments are necessarily indispensable and they may be selectively used as appropriate.

1. An air intake structure for an engine provided with an air cleaner disposed in a vicinity of an exhaust muffler, the air cleaner comprising:
a case defining an air intake chamber;
an air cleaner element housed in the case to divide the air intake chamber into a dust chamber and a clean chamber;
a first air inlet formed in a part of the case at a position close to the exhaust muffler such that the first air inlet communicates the dust chamber with an exterior of the case;
a second air inlet formed in a part of the case at a position distant from the exhaust muffler such that the second air inlet communicates the dust chamber with an exterior of the case;
a communication opening formed in the case so as to communicate the clean chamber with an air intake passage for supplying air to a combustion chamber; and
an opening and closing mechanism capable of selectively opening and closing at least one of the first and second air inlets.

2. The air intake structure for an engine according to claim 1, wherein the opening and closing mechanism includes a member configured to be movable to a first position and a second position, wherein at the first position, the member closes the first air inlet and opens the second air inlet, and at the second position, the member opens the first air inlet and closes the second air inlet.

3. The air intake structure for an engine according to claim 2, wherein the member is configured to be movable to a third position where the member closes both the first and second air inlets.

4. The air intake structure for an engine according to claim 2, wherein the first and second air inlets are formed in a part of a wall of the case, and
the member includes a shutter plate rotatably movable along a surface of the wall so as to open and close the first and second air inlets.

5. The air intake structure for an engine according to claim 1, wherein the opening and closing mechanism includes a first valve installed at the first air inlet and a second valve installed at the second air inlet.

6. The air intake structure for an engine according to claim 1, the opening and closing mechanism is connected to a choke mechanism of the engine via an interlocking mechanism which causes the opening and closing mechanism to open the first air inlet and close the second air inlet when an opening degree of a choke valve is smaller than a first predetermined choke valve opening degree, and to cause the opening and closing mechanism to close the first air inlet and open the second air inlet when the opening degree of the choke valve is larger than a second predetermined choke valve opening degree that is larger than or equal to the first predetermined choke valve opening degree.

7. The air intake structure for an engine according to claim 1, wherein the opening and closing mechanism is connected to a throttle mechanism of the engine via an interlocking mechanism which causes the opening and closing mechanism to open the first air inlet and close the second air inlet when an opening degree of a throttle valve is smaller than a first predetermined throttle valve opening degree, and to cause the opening and closing mechanism to close the first air inlet and open the second air inlet when the opening degree of the throttle valve is larger than a second predetermined throttle valve opening degree that is larger than or equal to the first predetermined throttle valve opening degree.

8. The air intake structure for an engine according to claim 1, further comprising:
a drive unit that drives the opening and closing mechanism;
a controller that controls the drive unit; and
at least one sensor selected from the group consisting of a choke valve opening degree sensor, a throttle valve opening degree sensor, an intake air temperature sensor, an engine temperature sensor, an oil temperature sensor and a water temperature sensor,
wherein the controller controls the drive unit based on a result of detection by the at least one sensor to drive the opening and closing mechanism.

9. The air intake structure for an engine according to claim 1, wherein a distance between the first air inlet and the exhaust muffler is smaller than a distance between the second air inlet and the exhaust muffler.
